(19) United States
(12) Patent Application Publication
(10) Pub. No.: US 2012/0087001 A1
(43) Pub. Date: Apr. 12, 2012

(54) ELECTRONIC PAPER DISPLAY DEVICE AND METHOD OF MANUFACTURING THE SAME

(75) Inventors: Choong Hee LEE, Gyeonggi-do (KR); Young Woo LEE, Gyeonggi-do (KR); Yong Soo OH, Gyeonggi-do (KR); Hye Yeon CHA, Gyeonggi-do (KR); Hwan Soo LEE, Gyeonggi-do (KR)

(73) Assignee: SAMSUNG ELECTRO-MECHANICS CO., LTD.

(21) Appl. No.: 13/023,939

(22) Filed: Feb. 9, 2011

(30) Foreign Application Priority Data
Oct. 6, 2010 (KR) 10-2010-0097279

(51) Int. Cl. G02B 26/00; H01J 9/00

(52) U.S. Cl. 359/296; 445/24

(57) ABSTRACT

The present invention provides an electronic paper display device including: a base substrate; rotating balls positioned on the base substrate and consisting of hemispheres of different colors; and a barrier structure for separating the rotating balls on the base substrate and having cavities in which the rotating balls are positioned and an oil supply passage connected to the cavities to supply oil to the cavities.

### CROSS-REFERENCE TO RELATED APPLICATIONS

This application claims the benefit under 35 U.S.C. Section 119 of Korean Patent Application Serial No. 10-2010-0097279, entitled “Electronic Paper Display Device And Method Of Manufacturing The Same”, filed on Oct. 6, 2010, which is hereby incorporated by reference in its entirety into this application.”

### BACKGROUND OF THE INVENTION

1. Field of the Invention

The present invention relates to an electronic paper display device and a method of manufacturing the same, and more particularly, to an electronic paper display device capable of improving manufacturing process efficiency, and a method of manufacturing the same.

2. Description of the Related Art

Among next generation display devices, an electronic paper display device is characterized in that it has higher availability and flexibility compared to other display devices and is driven with low power. Accordingly, the electronic paper display device can substitute paper printing media such as books and be applied to various kinds of fields such as screens and electronic wallpaper.

A representative electronic paper display device is a twist ball type electronic paper display device which uses a rotating ball consisting of hemispheres of different colors. The twist ball type electronic paper display device includes a plurality of rotating balls, a barrier structure for separating the rotating balls, an electrode structure for rotating the rotating balls, and transparent insulating oil for providing lubricity to the rotating balls.

Meanwhile, there are the following methods of filling the insulating oil in cavities in a process of manufacturing the above electronic paper display device. As an example, there is a method of filling the insulating oil in the cavities through an injection path after securing the injection path in a space between the barrier structure and the electrode structure by separating the barrier structure and the electrode structure from each other. As another example, there is a method of filling the insulating oil in the cavities by manufacturing the barrier structure with an oil absorbent material so that the barrier structure absorbs the insulating oil. For this, the barrier structure is made of an oil absorbent material such as polydimethylsiloxane (PDMS).

However, in case of separating the barrier structure and the electrode structure from each other in order to secure the injection path, it is difficult to uniformly maintain an interval between the barrier structure and the electrode structure as size of the electronic paper display device increases. For example, the interval between the barrier structure and the electrode structure is relatively larger in a center region of the electronic paper display device than in an edge region of the electronic paper display device.

Further, in case of using the method of absorbing the oil through the barrier structure, since the barrier structure expands by absorbing the oil, size and shape of the cavities are deformed. Especially, since the size of the cavities increases due to the expansion of the barrier structure, an interval between the rotating balls and the cavities increases. In this case, since an interval between the cavities also increases and becomes non-uniform, characteristics of the electronic paper display device such as color contrast are deteriorated.

### SUMMARY OF THE INVENTION

The present invention has been invented in order to overcome the above-described problems and it is, therefore, an object of the present invention to provide an electronic paper display device having a structure capable of effectively filling insulating oil in cavities.

It is another object of the present invention to provide a method of manufacturing an electronic paper display device having a structure capable of effectively filling insulating oil in cavities.

In accordance with one aspect of the present invention to achieve the object, there is provided an electronic paper display device including: a base substrate; rotating balls disposed on the base substrate; and a barrier structure for separating the rotating balls, wherein the barrier structure includes cavities in which the rotating balls are positioned and an oil supply passage connected to the cavities to supply oil to the cavities.

In accordance with an embodiment of the present invention, the oil supply passage may be connected to the cavities on a different plane from the cavities in the barrier structure.

In accordance with an embodiment of the present invention, the cavities may be separated from each other, and the oil supply passage may be disposed on a plane closer to the base substrate than the cavities in the barrier structure and communicate with the cavities through an upper surface thereof.

In accordance with an embodiment of the present invention, the rotating balls may be disposed in a lattice shape, and the oil supply passage may have a line shape to connect the cavities, which are disposed on the same line, among the cavities.

In accordance with an embodiment of the present invention, the rotating balls may be disposed in a lattice shape, and the oil supply passage may have a lattice shape to connect the cavities.

In accordance with an embodiment of the present invention, the rotating balls may be disposed in a zigzag shape, and the oil supply passage may be connected to the cavities which define spaces for positioning the rotating balls disposed in a zigzag shape.

In accordance with an embodiment of the present invention, the barrier structure may include an upper layer having the cavities and a lower layer which is positioned closer to the base substrate than the upper layer and has the oil supply passage.

In accordance with an embodiment of the present invention, the base substrate may be used as an electrode for applying voltage to the rotating balls for rotation of the rotating balls.

In accordance with an embodiment of the present invention, the electronic paper display device may further include an electrode structure for applying voltage to the rotating balls, wherein the electrode structure may include a lower electrode which covers a lower portion of the barrier structure and an upper electrode which covers an upper portion of the barrier structure to seal open upper portions of the cavities.

In accordance with an embodiment of the present invention, the electronic paper display device may further include a bonding layer which is interposed between the barrier structure and the upper electrode to bond the barrier structure and the upper electrode.

In accordance with another aspect of the present invention to achieve the object, there is provided an electronic paper display device including: rotating balls consisting of hemispheres of different colors; a barrier structure for separating the rotating balls in a lateral direction while surrounding each of the rotating balls; a lower electrode coupled to a lower portion of the barrier structure; and an upper electrode coupled to an upper portion of the barrier structure, wherein the barrier structure includes cavities in which the rotating balls are positioned and an oil supply passage connected to the cavities to supply oil to the cavities.

In accordance with an embodiment of the present invention, the oil supply passage may be disposed on a plane closer to the lower electrode than the cavities and communicate with the cavities through an upper surface thereof.

In accordance with an embodiment of the present invention, each of the cavities may include an upper opening open toward the upper electrode and a lower opening open toward the lower electrode, the upper opening may be used as a rotating ball insertion hole for insertion of the rotating ball, and the lower opening may be used as an oil supply hole for receiving the oil through the oil supply passage.

In accordance with an embodiment of the present invention, the electronic paper display device may further include a light transmitting transparent bonding layer which is interposed between the barrier structure and the upper electrode to bond the barrier structure and the upper electrode.

In accordance with still another aspect of the present invention to achieve the object, there is provided a method of manufacturing an electrode paper display device including the steps of: preparing a base substrate; forming a barrier structure having cavities on the base substrate; positioning rotating balls in the cavities; and sealing upper openings of the cavities, wherein the step of forming the barrier structure includes the step of forming an oil supply passage which is connected to the cavities to supply oil to the cavities.

In accordance with an embodiment of the present invention, the step of forming the oil supply passage may include the steps of forming a second pattern to cover a passage forming region of the base substrate, forming a dielectric layer to cover the base substrate and the second pattern, forming holes in the dielectric layer to expose the second pattern, and removing the second pattern.

In accordance with an embodiment of the present invention, the step of forming the second pattern may include the steps of forming a first pattern on the base substrate to expose the passage forming region, forming an insulating layer which covers the base substrate and the first pattern and has an etching selectivity compared to the first pattern, and planarizing the insulating layer by using an upper surface of the first pattern as an etch stop layer.

In accordance with an embodiment of the present invention, the step of forming the second pattern may include the steps of forming the first pattern on the base substrate to expose the passage forming region, forming a seed layer on the base substrate exposed by the first pattern, and forming a plating layer on the passage forming region by performing a plating process using the seed layer as a seed.

In accordance with an embodiment of the present invention, the step of forming the second pattern may further include the step of planarizing the plating layer by using the upper surface of the first pattern as an etch stop layer.

In accordance with an embodiment of the present invention, the step of removing the second pattern may include the step of supplying an etchant having an etching selectivity with respect to the second pattern through the holes.

In accordance with an embodiment of the present invention, the second pattern may be formed in a shape corresponding to that of the oil supply passage.

In accordance with an embodiment of the present invention, the step of preparing the base substrate may include the step of preparing a plate-shaped electrode for applying voltage to the rotating balls.

In accordance with an embodiment of the present invention, the step of sealing the upper openings of the cavities may include the step of bonding the electrode for applying voltage to the rotating balls to the barrier structure.

In accordance with an embodiment of the present invention, the step of bonding the electrode may include the step of forming a bonding layer on a bonding surface of the electrode, which is bonded to the barrier structure, and bonding the electrode to the barrier structure with the bonding layer interposed therebetween.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view showing an electronic paper display device in accordance with an embodiment of the present invention;

FIG. 2 is a plan view showing the electronic paper display device shown in FIG. 1;

FIG. 3 is a cross sectional view taken along line I-I′ shown in FIG. 2;

FIG. 4 is a cross sectional view taken along line II-II′ shown in FIG. 2;

FIG. 5 is a flow chart showing a method of manufacturing an electronic paper display device in accordance with an embodiment of the present invention;

FIGS. 6 to 12 are views for explaining a process of manufacturing an electronic paper display device in accordance with an embodiment of the present invention;

FIG. 13 is a view showing an electronic paper display device in accordance with a modified example of the present invention;

FIG. 14 is a view showing an electronic paper display device in accordance with another modified example of the present invention; and

FIG. 15 is a view showing an electronic paper display device in accordance with still another modified example of the present invention.

### DETAILED DESCRIPTION OF THE PREFERABLE EMBODIMENTS

Advantages and features of the present invention and methods of accomplishing the same will be apparent with reference to the following embodiments described in detail in conjunction with the accompanying drawings. However, the present invention is not limited to the following embodiments but may be embodied in various other forms. The embodiments are provided to complete the disclosure of the present invention and to completely inform a person with average knowledge in the art of the scope of the present invention. Like reference numerals refer to like elements throughout the specification.

Terms used herein are provided to explain embodiments, not limiting the present invention. Throughout this specification, the singular form includes the plural form unless the context clearly indicates otherwise. The terms “comprise” and/or “comprising” do not exclude the existence or addition of one or more different components, steps, operations, and/or elements.

Hereinafter, an electronic paper display device and a method of manufacturing the same in accordance with embodiments of the present invention will be described in detail with reference to the accompanying drawings.

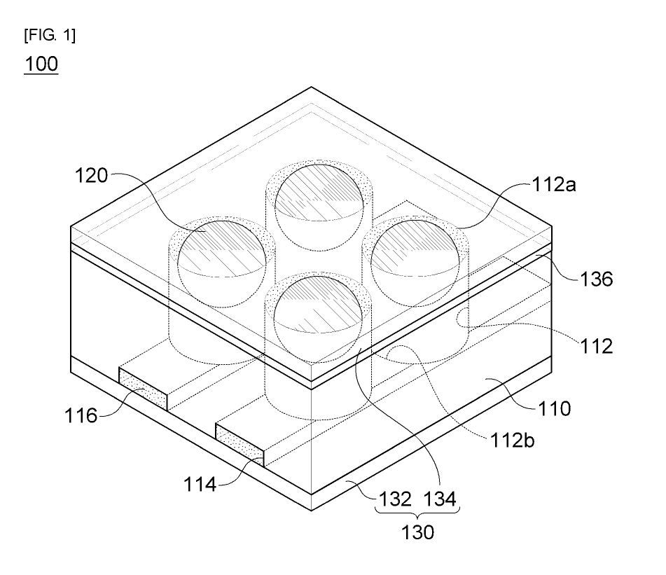

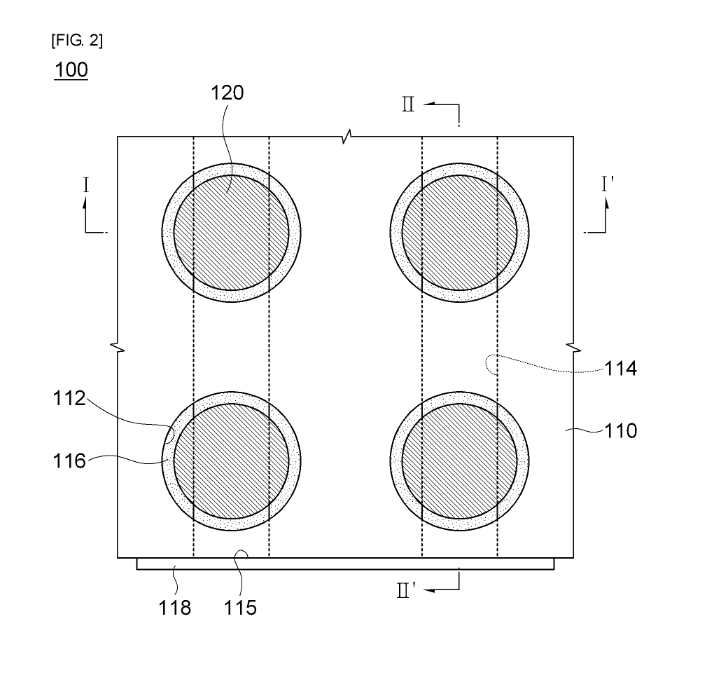

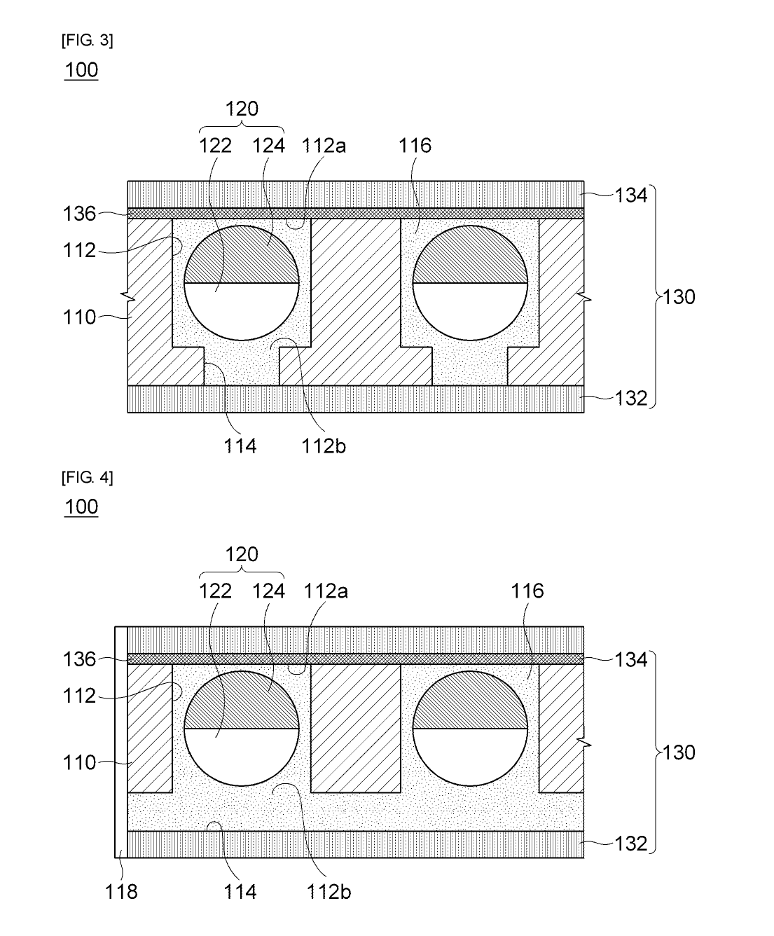

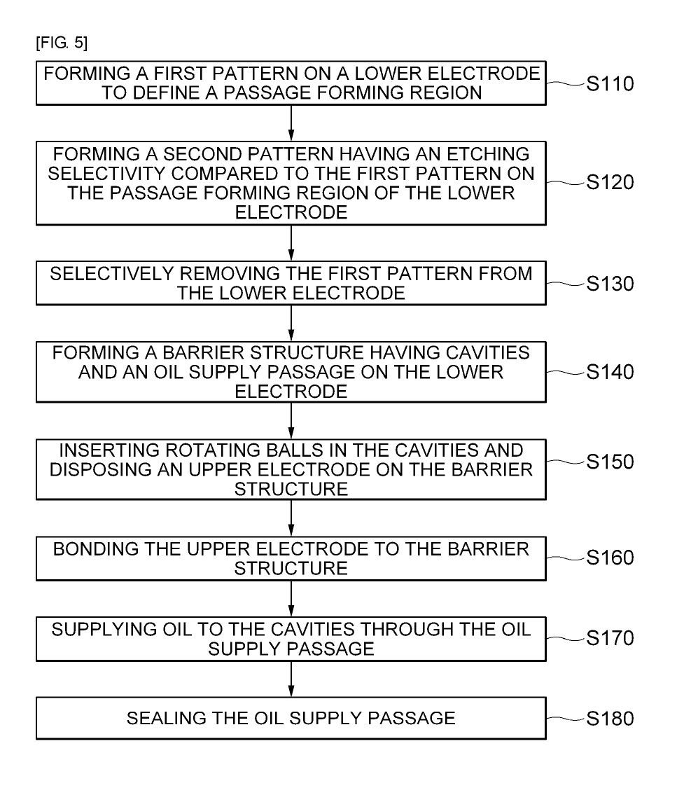

FIG. 1 is a perspective view showing an electronic paper display device in accordance with an embodiment of the present invention, and FIG. 2 is a plan view showing the electronic paper display device shown in FIG. 1. FIG. 3 is a cross sectional view taken along line I-I′ shown in FIG. 2, and FIG. 4 is a cross sectional view taken along line II-II′ shown in FIG. 2.

Referring to FIGS. 1 to 4, an electronic paper display device 100 in accordance with an embodiment of the present invention may include a barrier structure 110, rotating balls 120, and an electrode structure 130.

The barrier structure 110 may support and separate the rotating balls 120. The barrier structure 110 may have recessed portions which define cavities 112. The cavities 112 may provide spaces for positioning the rotating balls 120 in the barrier structure 110. By the cavities 112, the rotating balls 120 can be separated from each other in the barrier structure 110. Insulating oil 116 may be filled in the cavities 112. The insulating oil 116 may provide rotational lubricity of the rotating balls 120. The insulating oil 116 may be made of a light transmitting transparent material.

The barrier structure 110 may separate each of the rotating balls 120. For example, the barrier structure 110 may have a structure surrounding circumferences of the rotating balls 120, and the cavities 112 may have a structure sealed to each other in a lateral direction. In case that the cavities are open to each other in a lateral direction, if one of the rotating balls positioned in the cavities is rotated, rotary power of the rotating ball may directly or indirectly affect the adjacent rotating balls. In this case, since the rotation of one of the rotating balls affects other rotating balls, rotational characteristics of the rotating balls may be deteriorated. In order to prevent this, the barrier structure 110 may be configured to provide an independent space to each of the rotating balls 120. Therefore, the independent rotational characteristics of each of the rotating balls 120 are normally maintained by preventing the rotary power of one rotating ball 120 from affecting other rotating balls 120.

Each of the rotating balls 120 may have a spherical shape consisting of first and second hemispheres 122 and 124. The first and second hemispheres 122 and 124, which form one rotating ball 120, may have different colors. As an example, in case that the electronic paper display device 100 is a black display device, the first hemisphere 122 may be a white hemisphere, and the second hemisphere 124 may be a black hemisphere. As another example, in case that the electronic paper display device 100 is a color display device, the first hemisphere 122 may be one of red, green, blue, cyan, magenta, yellow, white, and black hemispheres, and the second hemisphere 124 may be another of red, green, blue, cyan, magenta, yellow, white, and black hemispheres. The colors of the first and second hemispheres 122 and 124 of each of the rotating balls 120 may be variously changed and combined, and they may be not limited to the above-described examples. In addition, the first and second hemispheres 122 and 124 may be electrified with different charges or only one of the first and second hemispheres 122 and 124 may be electrified.

The electrode structure 130 may rotate the rotating balls 120. For example, the electrode structure 130 may include a lower electrode 132 disposed in a lower portion of the barrier structure 110 and an upper electrode 134 disposed in an upper portion of the barrier structure 110. The lower and upper electrodes 132 and 134 may rotate the rotating ball 120 so that one of the first and second hemispheres 122 and 124, which has a color to express, faces outward (upward in FIG. 1) by selectively applying voltage to the rotating ball 120. Here, the lower electrode 132 may be used as a base substrate for manufacturing components of the electronic paper display device 100. For example, the barrier structure 110 and the upper electrode 134 may be sequentially formed on the lower electrode 132 by using the lower electrode 132 as a base substrate.

The electrode structure 130 may further include a bonding layer 136. For example, the bonding layer 136 may be interposed between the barrier structure 110 and the upper electrode 134 to bond the barrier structure 110 and the upper electrode 134. It may be preferred that the bonding layer 136 is made of a transparent material having high light transmittance. As an example, the bonding layer 136 may be made of at least one of a thermosetting resin and a photocurable resin. Since the upper electrode 134 is bonded to the barrier structure 110 with the separate bonding layer 136 interposed therebetween, the barrier structure 110 and the upper electrode 134 may be closely bonded to each other. Accordingly, a separation space may not be provided between the barrier structure 110 and the upper electrode 134.

Although the above embodiment illustrates a case in which both of the lower electrode 132 and the upper electrode 134 have a plate shape, the lower electrode 132 and the upper electrode 134 may have various shapes to independently drive each of the rotating balls 120. For example, at least one of the lower electrode 132 and the upper electrode 134 may have a plate shape, and the other of the lower electrode 132 and the upper electrode 134 may have a line shape to face each of the rotating balls 120. Accordingly, each of the rotating balls 120 can be independently rotated by the electrode structure 130.

Here, the barrier structure 110 may further include an oil supply passage 114. The oil supply passage 114 may be a path for injecting the transparent insulating oil 116 into the cavities 112. The oil supply passage 114 may have a line shape communicating with the cavities 112. An injection hole 115 may be formed at an outer edge of the electronic paper display device 100 to inject the insulating oil 116 into the oil supply passage 114. At least one injection hole 115 may be formed on a side surface of an edge of the electronic paper display device 100. The injection hole 115 may be covered and sealed with a predetermined sealing member 118.

Further, the oil supply passage 114 may be provided on a different plane from the cavities 112. As an example, the cavities 112 may be disposed on a plane relatively close to the upper electrode 134 in the barrier structure 110, and the oil supply passage 114 may be disposed on a plane relatively close to the lower electrode 132 in the barrier structure 110. Accordingly, the oil supply passage 114 may be formed under the cavities 112, and an upper surface of the oil supply passage 114 may communicate with the cavities 112.

Meanwhile, each of the cavities 112 may include an upper opening 112a and a lower opening 112b. For example, the upper opening 112a may be an opening open toward the upper electrode 134, and the lower opening 112b may be an opening open toward the lower electrode 132. The upper opening 112a may be used as a ball insertion hole for inserting the rotating ball 120 in the cavity 112, and the lower opening 112b may be used as an oil supply hole for receiving the oil 116 from the oil supply passage 114.

As described above, the electrode paper display device 100 in accordance with an embodiment of the present invention may include the barrier structure 110 having the cavities 112 in which the rotating balls 120 are positioned, and the barrier structure 110 may include the oil supply passage 114 for supplying the oil 116 to each of the cavities 112. Accordingly, the electronic paper display device 100 in accordance with an embodiment of the present invention can have a structure capable of improving supply and injection efficiency of the oil 116 by precisely supplying the oil 116 to each of the cavities 112.

The electronic paper display device 100 in accordance with an embodiment of the present invention may include the barrier structure 110 having the cavities 112 in which the rotating balls 120 are positioned and the oil supply passage 114 for supplying the oil 116 to the cavities 112, and the oil supply passage 114 may be positioned on the different plane from the cavities 112. In this case, the cavities 112 may be separated from each other in a lateral direction, and the oil supply passage 114 may supply the oil 116 through lower openings 112b of the cavities 112. Accordingly, the electronic paper display device 100 in accordance with an embodiment of the present invention can have a structure capable of improving rotational characteristics of the rotating balls 120 by preventing rotation of one rotating ball 120 from affecting the adjacent rotating balls 120, in comparison with a structure in which the cavities are open to each other in a lateral direction.

Further, the electronic paper display device 100 in accordance with an embodiment of the present invention may include the barrier structure 110 for supporting and separating the rotating balls 120 and the electrode structure 130 coupled to the barrier structure 110 to apply voltage to the rotating balls 120, and the barrier structure 110 and the electrode structure 130 may be closely bonded to each other. Especially, the upper electrode 134, which seals the cavities 112 of the barrier structure 110, may be configured so that the entire bonding surface of the upper electrode 134 is closely bonded to the barrier structure 110 with the bonding layer 136 disposed on the barrier structure 110. Accordingly, the electronic paper display device 100 in accordance with an embodiment of the present invention can have a structure with improved durability and stability by completely closely bonding the barrier structure 110 and the upper electrode 134, in comparison with a structure in which the barrier structure and the electrode structure are spaced apart from each other to supply oil through a gap therebetween.

Continuously, a method of manufacturing an electronic paper display device will be described in detail. Here, a repeated description of the above-described electronic paper display device 100 will be omitted or simplified.

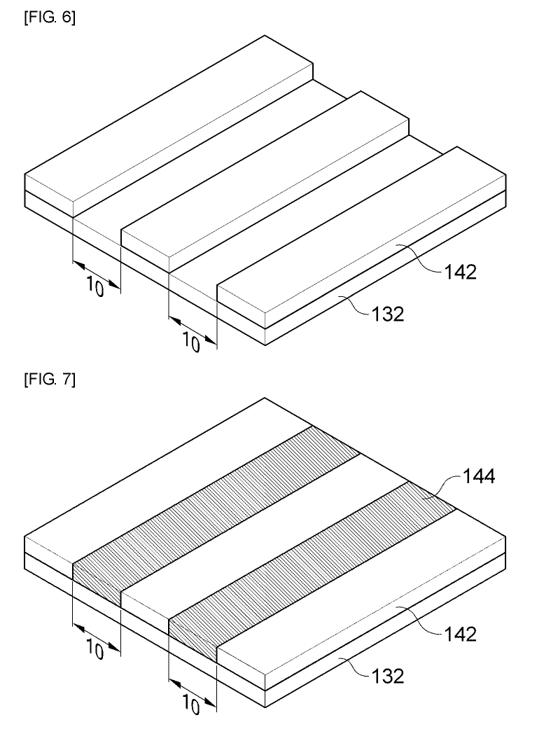

FIG. 5 is a flow chart showing a method of manufacturing an electronic paper display device in accordance with an embodiment of the present invention, and FIGS. 6 to 12 are views for explaining a process of manufacturing an electronic paper display device in accordance with an embodiment of the present invention.

Referring to FIGS. 5 and 6, a first pattern 142 having a trench for defining a passage forming region 10 may be formed on a base substrate (S110). For example, the base substrate may be prepared. The base substrate may be a support plate for forming components of an electronic paper display device thereon. The base substrate may be a plate-shaped electrode for applying rotation driving voltage to rotating balls. As an example, the step of preparing the base substrate may include the step of preparing a lower electrode 132. The step of preparing the lower electrode 132 may include the step of preparing a metal plate having conductivity. The metal plate may be a conductive plate made of copper (Cu).

A first layer may be formed on the lower electrode 132. The step of forming the first layer may be performed by forming an insulating layer which covers the entire surface of the lower electrode 132 with a uniform thickness. The insulating layer may be a photo-reactive insulating film such as dry film resist (DFR). In case that the first layer is DFR, the step of forming the first layer may be performed by laminating DFR on the entire surface of the lower electrode 132.

And, a portion of the first layer may be selectively removed to expose the passage forming region 10 of the lower electrode 132. For example, the step of removing the first layer may be performed by selectively patterning the first layer on the passage forming region 10 through a photolithography process. Through the above process, the first pattern 142 having the trench for exposing the passage forming region 10 may be formed on the lower electrode 132.

Meanwhile, although the present embodiment illustrates a case in which the components of the electronic paper display device are sequentially formed on the lower electrode 132 by using the lower electrode 132 as the base substrate, the components of the electronic paper display device may be sequentially formed on the base substrate by preparing the separate base substrate (not shown). In this case, the lower electrode 132 may be provided on the base substrate.

Referring to FIGS. 5 and 7, a second pattern 144 having an etching selectivity compared to the first pattern 142 may be formed on the passage forming region 10 of the lower electrode 32. For example, the step of forming the second pattern 144 may include the steps of forming a second layer on the lower electrode 132 and planarizing the second layer to expose an upper surface of the first pattern 142,

The second layer may be formed by various methods. As an example, the step of forming the second pattern 144 may be performed by planarizing the second layer using the upper surface of the first pattern 142 as an etch stop layer after forming a second insulating layer which covers the lower electrode 132 and the first pattern 142. At this time, a layer having an etching selectivity compared to the first pattern 142 may be used as the second insulating layer. As another example, the step of forming the second pattern 144 may be performed by planarizing a plating layer using the upper surface of the first pattern 142 as an etch stop layer after selectively forming the plating layer on the passage forming region 10 of the lower electrode 132. In case of forming the second pattern 144 by a plating process, before performing a process of forming the plating layer, the step of forming a seed layer on the passage forming region 10 of the lower electrode 132 may be added or the process of forming the plating layer may use the lower electrode 132 as a seed layer for forming the plating layer.

Through the above process, the first pattern 142 and the second pattern 144 having an etching selectivity compared to the first pattern 142 may be formed on the lower electrode 132.

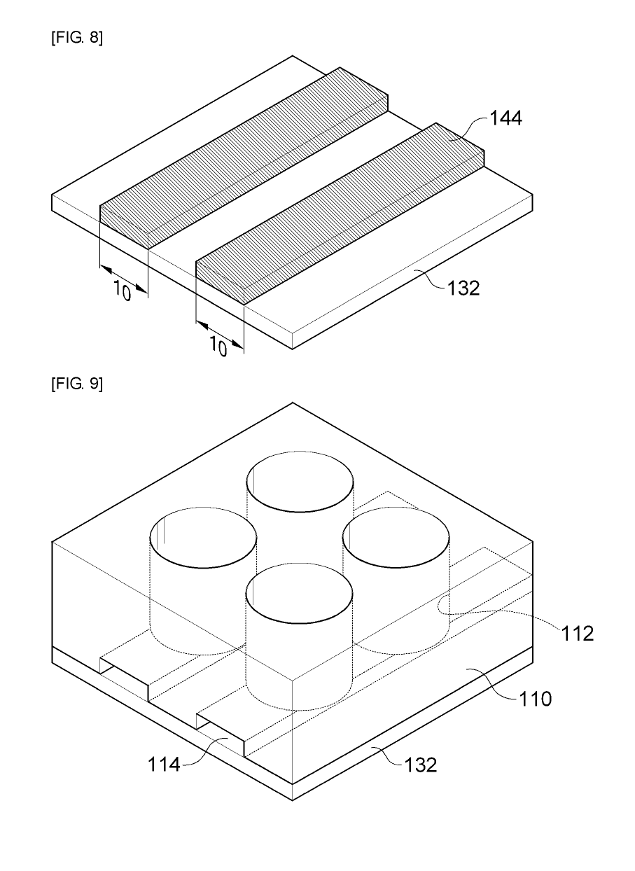

Referring to FIGS. 5 and 8, the first pattern 142 of FIG. 7 may be selectively removed from the lower electrode 132 (S130). The step of removing the first pattern 142 may be performed by performing an etching process on the lower electrode 132 at a higher etching speed with respect to the first pattern 142 than the second pattern 142. As an example, in case that the first pattern 142 is DFR, the step of removing the first pattern 142 may be performed by developing the first pattern 142 after performing an exposure process on the first pattern 142. Accordingly, the second pattern 144 may be formed on the lower electrode 132 to selectively cover the passage forming region 10.

Referring to FIGS. 5 and 9, a barrier structure 110 having cavities 112 and an oil supply passage 114 may be formed on the lower electrode 132 (S140).

First, a dielectric layer may be formed on the lower electrode 132 on which the second pattern 144 is formed. The step of forming the dielectric layer may be performed by laminating an insulating film on the lower electrode 132. At this time, since the insulating film is formed on the lower electrode 132 while being pressed and heated, the dielectric layer having a uniform upper surface may be formed on the lower electrode 132 to cover the second pattern 144. Here, in case that the second pattern 144 is a plating layer, since the plating layer has a relatively high strength, it can be prevented from being deformed or damaged in a process of pressing and heating the insulating film on the lower electrode 132.

The cavities 112 may be formed to expose the second pattern 144. For example, the step of forming holes in the dielectric layer to selectively expose the second pattern 144 may be included. The step of forming the holes may be performed by at least one of a laser process, a drilling process, an imprinting process, and a photolithography process.

And, the second pattern 144 may be removed. The step of removing the second pattern 144 may be performed by an etching process having an etching selectivity with respect to the second pattern 144. For example, an etchant having an etching selectivity with respect to the second pattern 144 may be supplied to the cavities 112 so that the second pattern 144 is removed by the etchant. Accordingly, the barrier structure 110, which has the cavities 112 and the oil supply passage 114 formed on a different plane from the cavities 112 to be connected to the cavities 112, may be formed on the lower electrode 132 by selectively removing the second pattern 144.

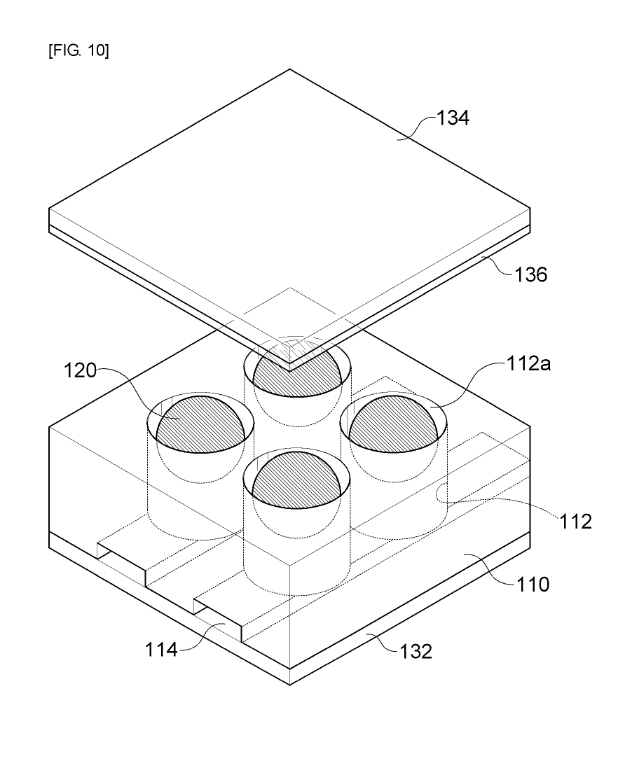

Referring to FIGS. 5 and 10, an upper electrode 134 may be bonded on the barrier structure 110 after inserting rotating balls 120 in the cavities 112 (S160).

First, the rotating balls 120 may be prepared. Each of the rotating balls 120 may consist of first and second hemispheres 122 and 124 having different colors, and the first and second hemispheres 122 and 124 may be electrified with different charges or only one of the first and second hemispheres 122 and 124 may be electrified. The rotating balls 120 may be selectively inserted in the desired cavities 112 through upper openings 112a of the cavities 112.

And, a light transmitting transparent electrode for the upper electrode 134 may be prepared. The transparent electrode may have a plate or line shape. At this time, a bonding layer 136 may be formed on a bonding surface of the transparent electrode, which faces the barrier structure 110. The bonding layer 136 is to bond the upper electrode 134 to the barrier structure 110, and it may be preferred that the bonding layer 136 is made of a light transmitting transparent material. The bonding layer 136 may be made of a resin material.

The upper electrode 134 may be disposed on the barrier structure 110 with the bonding layer 136 interposed therebetween. And, the upper electrode 134 may be bonded to the barrier structure 110 by performing heat treatment on the bonding layer 136. In a process of bonding the barrier structure 110 and the upper electrode 134, the step of pressing the upper electrode 134 to the barrier structure 110 may be added.

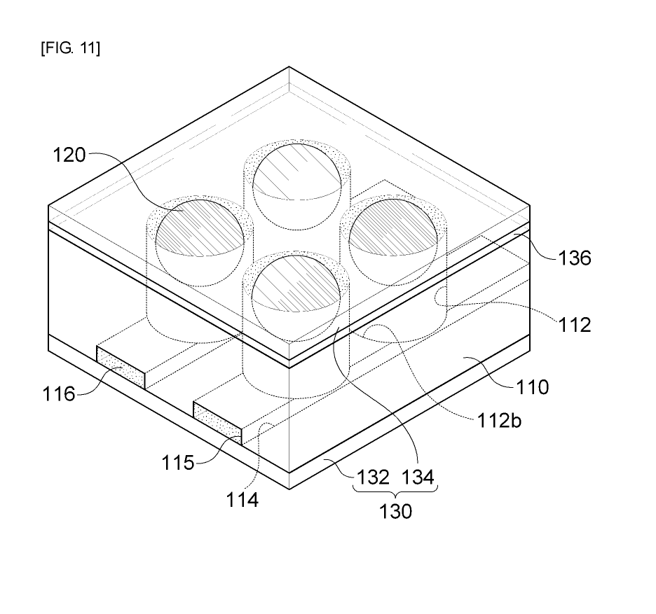

Referring to FIGS. 5 and 11, oil 116 may be supplied to the cavities 112 through the oil supply passage 114 (S180). For example, the oil 116 may be injected into the oil supply passage 114 through an injection hole 115 of the oil supply passage 114 provided at a side surface of an edge of an electronic paper display device. The oil 116 may flow along the oil supply passage 114 to be supplied to the cavities 112 through lower openings 112b of the cavities 112. In a process of supplying the oil 116, supply pressure of a predetermined size may be applied to the oil supply passage 114 for the effective supply of the oil 116.

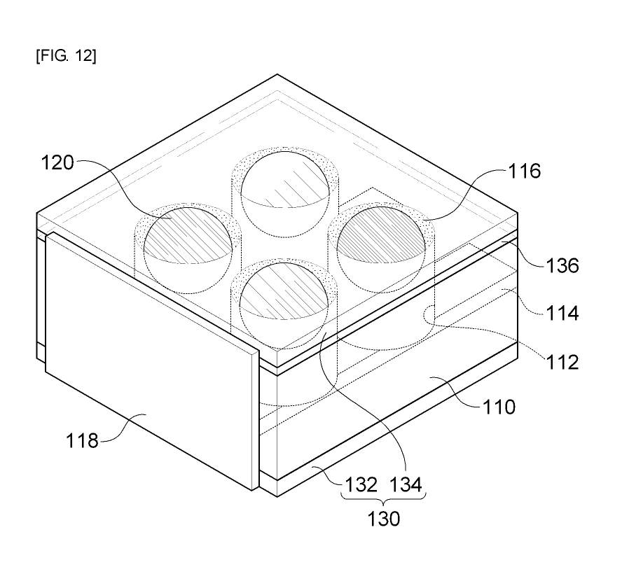

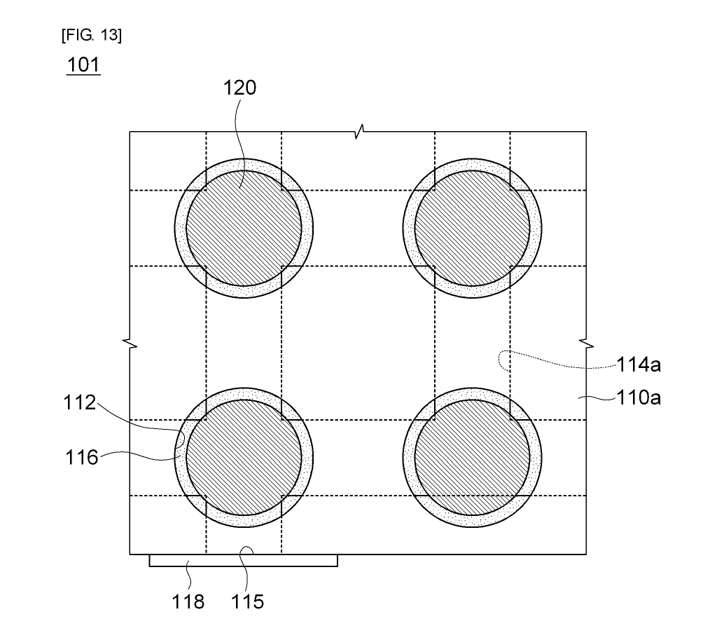

Referring to FIGS. 5 and 12, the oil supply passage 114 may be sealed (S190). For example, a sealing member 118 may be formed to cover the injection hole 115 of FIG. 11 of the oil supply passage 114. The step of forming the sealing member 118 may be performed by coating a sealing material on a region adjacent to the injection hole 115. At this time, the sealing member 118 may be formed to surround the side surface of the edge of the electronic paper display device or the sealing member 118 may be formed to selectively cover only the injection hole 115.

As described above, the method of manufacturing an electronic paper display device 100 can supply the oil 116 to the cavities 112 through the oil supply passage 114 by forming the oil supply passage 114 in the barrier structure 110 to be connected to the cavities 112. Accordingly, the method of manufacturing an electronic paper display device in accordance with the present invention can improve manufacturing efficiency of an electronic paper display device by effectively injecting the oil for rotational lubricity of the rotating balls into the cavities through the oil supply passage formed in the barrier structure.

The method of manufacturing an electronic paper display device 100 in accordance with an embodiment of the present invention forms the barrier structure 110 having the cavities 112 in which the rotating balls 120 are positioned and the oil supply passage 114 connected to the cavities 112, on the lower electrode 132, and the oil supply passage 114 may be formed on the different plane from the cavities 112 to be connected to the cavities 112. In this case, the cavities 112 may be formed to be separated from each other in a lateral direction. Accordingly, the method of manufacturing an electronic paper display device in accordance with the present invention can manufacture an electronic paper display device having a structure capable of improving rotational characteristics of the rotating balls 120 by independently separating the cavities 112 to prevent rotation of one rotating ball 120 from affecting the adjacent rotating balls 120.

Further, the method of manufacturing an electronic paper display device 100 in accordance with an embodiment of the present invention can manufacture an electronic paper display device having a structure in which the barrier structure 110 and the upper electrode 134 of the electrode structure 130 are closely bonded by the bonding layer 136. Accordingly, the method of manufacturing an electronic paper display device in accordance with the present invention can manufacture an electronic paper display device with high durability and stability by completely closely bonding the barrier structure 110 and the electrode structure 130.

Hereinafter, electronic paper display devices in accordance with various modified examples of the present invention will be described in detail. Here, a repeated description of the above-described electronic paper display device 100 in accordance with an embodiment of the present invention will be omitted or simplified.

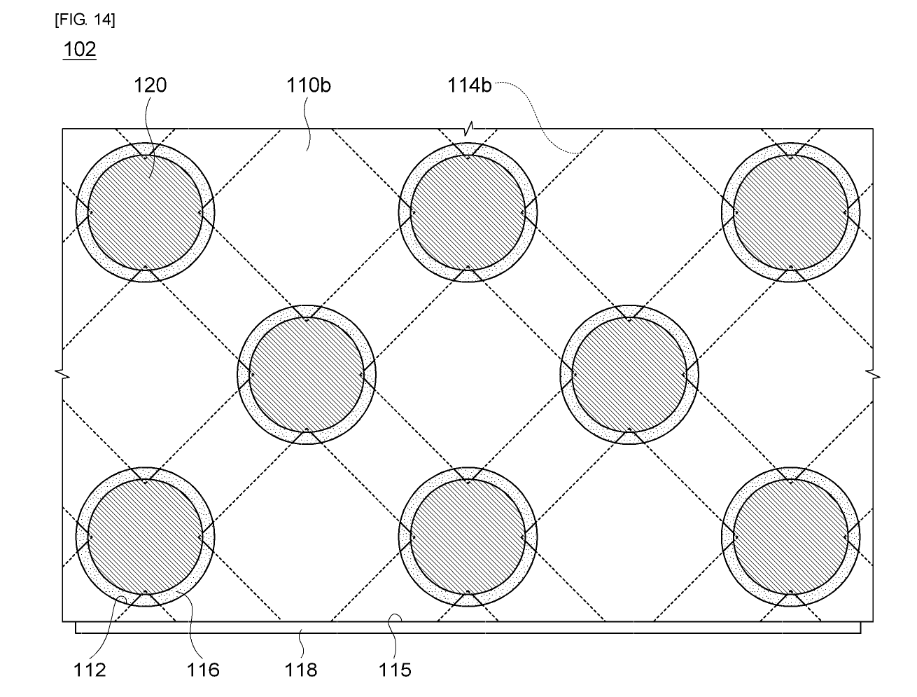

FIG. 13 is a view showing an electronic paper display device in accordance with a modified example of the present invention. Referring to FIG. 13, an electronic paper display device 101 in accordance with a modified example of the present invention may include a barrier structure 110a, rotating balls 120, and an electrode structure 130, and the barrier structure 110a may have a lattice-shaped oil supply passage 114a.

For example, the rotating balls 120 may be disposed in a lattice shape on a lower electrode 132 of the electrode structure 130. In this case, the oil supply passage 114a for supplying oil 116 to cavities 112 may also be formed in a lattice shape in correspondence to the cavities 112. The lattice-shaped oil supply passage 114a may be configured to be connected to all or most of the cavities 112 formed in the electronic paper display device 101.

The electronic paper display device 101 having the above structure may reduce the number of injection holes 115 for injecting the oil 116 into the oil supply passage 114a. In this case, the oil 116 may be supplied to all of the cavities 112 through one or several injection holes 115a, and a sealing member 118a for sealing the injection hole 115a may also be formed to cover only one or several injection holes 115a.

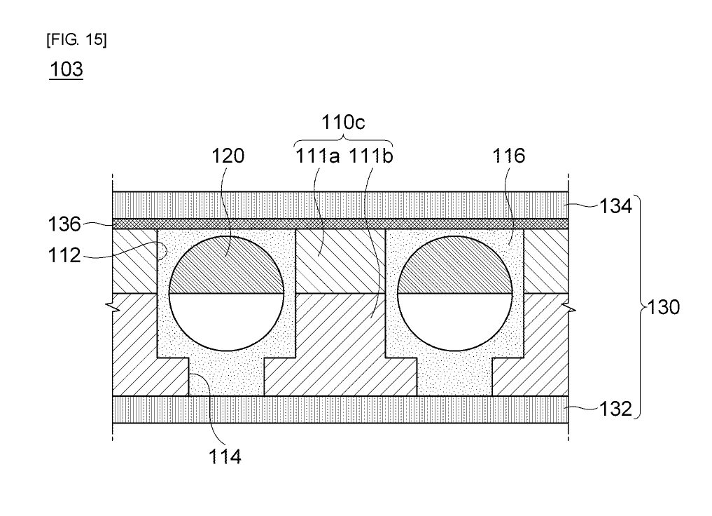

FIG. 14 is a view showing an electronic paper display device in accordance with another modified example of the present invention. Referring to FIG. 14, an electronic paper display device 102 in accordance with another modified example of the present invention may include a barrier structure 110b, rotating balls 120 disposed in a zigzag shape in the barrier structure 110b, and an electrode structure 130 for applying voltage to the rotating balls 120. Since the rotating balls 120 are disposed in a zigzag shape, cavities 112 of the barrier structure 110b, which provide spaces for positioning the rotating balls 120, may also be disposed in a zigzag shape, and an oil supply passage 114b may be configured to be connected to the cavities 112. For this, the oil supply passage 114b may be configured to have a lattice or zigzag shape.

FIG. 15 is a view showing an electronic paper display device in accordance with still another modified example of the present invention. Referring to FIG. 15, an electronic paper display device 103 in accordance with still another modified example of the present invention may include a barrier structure 110c for separating rotating balls 120 and an electrode structure 130 disposed in the barrier structure 110c to apply voltage to the rotating balls 120, and the barrier structure 110c may have a multilayer structure.

For example, since the barrier structure 110c in accordance with the present invention includes cavities 112 and an oil supply passage 114 which are formed at different heights, it can have a relatively large thickness in comparison with a barrier structure without the oil supply passage 114. There is a technical difficulty in forming the barrier structure 110c having a large thickness in a single-layer structure. Accordingly, the electronic paper display device 103 in accordance with still another modified example of the present invention can be formed in a multilayer structure. More specifically, the barrier structure 110c may consist of an upper layer 110a and a lower layer 111b. Here, the lower layer 110b may be configured to have the oil supply passage 114 and portions of the cavities 112, and the upper layer 110a may be configured to have the remaining portions of the cavities 112 or, as another example, the lower layer 110b may be configured to be divided into a layer in which the cavities 112 are formed and a layer in which the oil supply passage 114 is formed.

The electronic paper display device 103 having the above structure can manufacture the barrier structure 110c having the cavities 112 by bonding the lower layer 111b and the upper layer 111a with the rotating balls 120 interposed therebetween after forming the lower layer 111b on a lower electrode 132 and forming the upper layer 111a on an upper electrode 134. And, the electronic paper display device 103 can be manufactured by injecting oil 116 into the cavities 112 through the oil supply passage 114.

The electronic paper display device in accordance with the present invention may include the barrier structure having the cavities in which the rotating balls are positioned, and the barrier structure includes the oil supply passage for supplying the oil to each of the cavities. Accordingly, the electronic paper display device in accordance with the present invention can have a structure capable of improving the supply and injection efficiency of the oil by precisely supplying the oil to each of the cavities.

The electronic paper display device in accordance with the present invention may include the barrier structure having the cavities in which the rotating balls are positioned and the oil supply passage for supplying the oil to the cavities, and the oil supply passage may be positioned on the different plane from the cavities. In this case, the cavities may be separated from each other in a lateral direction, and the oil supply passage may supply the oil through the lower openings of the cavities. Accordingly, the electronic paper display device in accordance with the present invention can have a structure capable of improving the rotational characteristics of the rotating balls by preventing the rotation of one rotating ball from affecting the adjacent rotating balls, in comparison with a structure in which the cavities are open to each other in a lateral direction.

The electronic paper display device in accordance with the present invention may include the barrier structure for supporting and separating the rotating balls and the electrode structure coupled to the barrier structure to apply voltage to the rotating balls, and the barrier structure and the electrode structure may be closely bonded to each other. Accordingly, the electronic paper display device in accordance with the present invention can have a structure with high durability and stability by closely bonding the barrier structure and the upper electrode, in comparison with a structure in which the barrier structure and the electrode structure are spaced apart from each other to supply oil through a gap therebetween.

The method of manufacturing an electronic paper display device in accordance with the present invention may supply the oil to the cavities through the oil supply passage by forming the oil supply passage in the barrier structure to be connected to the cavities. Accordingly, the method of manufacturing an electronic paper display device in accordance with the present invention can improve the manufacturing efficiency of the electronic paper display device by effectively injecting the oil for the rotational lubricity of the rotating balls to each of the cavities through the oil supply passage formed in the barrier structure.

The method of manufacturing an electronic paper display device in accordance with the present invention may form the barrier structure having the cavities in which the rotating balls are positioned and the oil supply passage connected to the cavities, on the lower electrode, and the oil supply passage may be connected to the cavities on the different plane from the cavities. Accordingly, the method of manufacturing an electronic paper display device in accordance with the present invention can manufacture an electronic paper display device having a structure capable of improving the independent rotational characteristics of each of the rotating balls by independently separating the cavities to prevent the rotation of one rotating ball from affecting the adjacent rotating balls.

The method of manufacturing an electronic paper display device in accordance with the present invention may closely bond the barrier structure and the upper electrode of the electrode structure with the bonding layer interposed therebetween. Accordingly, the method of manufacturing an electronic paper display device in accordance with the present invention can manufacture an electronic paper display device with high durability and stability by closely bonding the barrier structure and the electrode structure.

The foregoing description illustrates the present invention. Additionally, the foregoing description shows and explains only the preferred embodiments of the present invention, but it is to be understood that the present invention is capable of use in various other combinations, modifications, and environments and is capable of changes and modifications within the scope of the inventive concept as expressed herein, commensurate with the above teachings and/or the skill or knowledge of the related art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

What is claimed is:

1. An electronic paper display device comprising:
a base substrate;
rotating balls disposed on the base substrate; and
a barrier structure for separating the rotating balls, wherein the barrier structure comprises:
cavities in which the rotating balls are positioned; and
an oil supply passage connected to the cavities to supply oil to the cavities.

2. The electronic paper display device according to claim 1, wherein the oil supply passage is connected to the cavities on a different plane from the cavities in the barrier structure.

3. The electronic paper display device according to claim 1, wherein the cavities are separated from each other, and the oil supply passage is disposed on a plane closer to the base substrate than the cavities in the barrier structure and communicates with the cavities through an upper surface thereof.

4. The electronic paper display device according to claim 1, wherein the rotating balls are disposed in a lattice shape, and the oil supply passage has a line shape to connect the cavities disposed on the same line, among the cavities.

5. The electronic paper display device according to claim 1, wherein the rotating balls are disposed in a lattice shape, and the oil supply passage has a lattice shape to connect the cavities.

6. The electronic paper display device according to claim 1, wherein the rotating balls are disposed in a zigzag shape, and the oil supply passage is connected to the cavities which define spaces for positioning the rotating balls disposed in a zigzag shape.

7. The electronic paper display device according to claim 1, wherein the barrier structure comprises:
an upper layer having the cavities; and
a lower layer positioned closer to the base substrate than the upper layer and having the oil supply passage.

8. The electronic paper display device according to claim 1, wherein the base substrate is used as an electrode for applying voltage to the rotating balls for rotation of the rotating balls.

9. The electronic paper display device according to claim 1, further comprising an electrode structure for applying voltage to the rotating balls, wherein the electrode structure comprises:
a lower electrode which covers a lower portion of the barrier structure; and
an upper electrode which covers an upper portion of the barrier structure to seal open upper portions of the cavities.

10. The electronic paper display device according to claim 9, further comprising a bonding layer interposed between the barrier structure and the upper electrode to bond the barrier structure and the upper electrode.

11. An electronic paper display device comprising:
rotating balls consisting of hemispheres of different colors;
a barrier structure for separating the rotating balls in a lateral direction while surrounding each of the rotating balls;
a lower electrode coupled to a lower portion of the barrier structure; and
an upper electrode coupled to an upper portion of the barrier structure, wherein the barrier structure comprises:
cavities in which the rotating balls are positioned; and
an oil supply passage connected to the cavities to supply oil to the cavities.

12. The electronic paper display device according to claim 11, wherein the oil supply passage is disposed on a plane closer to the lower electrode than the cavities and communicates with the cavities through an upper surface thereof.

13. The electronic paper display device according to claim 11, wherein each of the cavities comprises:
an upper opening open toward the upper electrode; and
a lower opening open toward the lower electrode, wherein the upper opening is used as a rotating ball insertion hole for insertion of the rotating ball, and the lower opening is used as a oil supply hole for receiving the oil through the oil supply passage.

14. The electronic paper display device according to claim 11, further comprising a light transmitting transparent bonding layer interposed between the barrier structure and the upper electrode to bond the barrier structure and the upper electrode.

15. A method of manufacturing an electronic paper display device comprising:
preparing a base substrate;
forming a barrier structure having cavities on the base substrate;
positioning rotating balls in the cavities; and
sealing upper openings of the cavities, wherein the forming the barrier structure comprises forming an oil supply passage connected to the cavities to supply oil to the cavities.

16. The method of manufacturing an electronic paper display device according to claim 15, wherein the forming the oil supply passage comprises:
forming a second pattern to cover a passage forming region of the base substrate;
forming a dielectric layer to cover the base substrate and the second pattern;
forming holes in the dielectric layer to expose the second pattern; and
removing the second pattern.

17. The method of manufacturing an electronic paper display device according to claim 16, wherein the forming the second pattern comprises:
forming a first pattern on the base substrate to expose the passage forming region;
forming an insulating layer which covers the base substrate and the first pattern and has an etching selectivity compared to the first pattern; and
planarizing the insulating layer by using an upper surface of the first pattern as an etch stop layer.

18. The method of manufacturing an electronic paper display device according to claim 16, wherein the forming the second pattern comprises:
forming a first pattern on the base substrate to expose the passage forming region;
forming a seed layer on the base substrate exposed by the first pattern; and
forming a plating layer on the passage forming region by performing an etching process using the seed layer as a seed.

19. The method of manufacturing an electronic paper display device according to claim 18, further comprising planarizing the plating layer by using an upper surface of the first pattern as an etch stop layer.

20. The method of manufacturing an electronic paper display device according to claim 15, wherein the removing the second pattern comprises supplying an etchant having an etching selectivity with respect to the second pattern through the holes.

21. The method of manufacturing an electronic paper display device according to claim 15, wherein the second pattern is formed in a shape corresponding to that of the oil supply passage.

22. The method of manufacturing an electronic paper display device according to claim 15, wherein the preparing the base substrate comprises preparing a plate-shaped electrode for applying voltage to the rotating balls.

23. The method of manufacturing an electronic paper display device according to claim 15, wherein the sealing the upper openings of the cavities comprises bonding the electrode for applying voltage to the rotating balls to the barrier structure.

24. The method of manufacturing an electrode paper display device according to claim 23, wherein the bonding the electrode comprises:
forming a bonding layer on a bonding surface of the electrode bonded to the barrier structure; and
bonding the electrode to the barrier structure with the bonding layer interposed therebetween.
